(19) United States
(12) Patent Application Publication
(10) Pub. No.: US 2023/0294881 A1
(43) Pub. Date: Sep. 21, 2023

(54) Fire Resistant Container Assembly

(71) Applicant: Taylor Burger, West Hartford, CT (US)

(72) Inventor: Taylor Burger, West Hartford, CT (US)

(21) Appl. No.: 17/697,512

(22) Filed: Mar. 17, 2022

(51) Int. Cl. B65D 25/28; B65D 25/04; B65D 43/02; B65D 65/38

(52) U.S. Cl. CPC B65D 25/2897; B65D 25/04; B65D 43/0222; B65D 65/38

(57) ABSTRACT

A fire resistant container assembly for protecting memorabilia from a fire includes a tub that is comprised of a fire impermeable material to withstand temperatures associated with a house fire. The tub has a pair of recesses each integrated into the tub such that each of the recesses defines a grip for gripping and lifting the tub. A divider is positioned within the tub to define a first compartment and a second compartment in the tub to store memorabilia associated with a deceased person. A lid is removably attachable to the tub and a groove is integrated into the lid. The groove insertably engages an upper threshold of the tub to inhibit heat from entering the tub. The lid is comprised of a fire impermeable material to withstand temperatures associated with a house fire.

### (B) CROSS-REFERENCE TO RELATED APPLICATIONS

Not Applicable

### (C) STATEMENT REGARDING FEDERALLY SPONSORED RESEARCH OR DEVELOPMENT

Not Applicable

### (D) THE NAMES OF THE PARTIES TO A JOINT RESEARCH AGREEMENT

Not Applicable

### (E) INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### (F) STATEMENT REGARDING PRIOR DISCLOSURES BY THE INVENTOR OR JOINT INVENTOR

Not Applicable

### (G) BACKGROUND OF THE INVENTION

### Field of the Invention

The disclosure relates to container devices and more particularly pertains to a new container device for protecting memorabilia from a fire. The device comprises a tub which is comprised of fire impermeable material for protecting memorabilia of a deceased person from fire. The tub has a pair of recesses which define grips for lifting the tube. The device includes a divider in the tub to define a pair of compartments and a lid which releasably engages the tub to protect the memorabilia from fire.

### Description of Related Art Including Information Disclosed Under 37 CFR 1.97 and 1.98

The prior art relates to container devices including a storage box which has a hinged lid and a flange defining a base of the box. The prior art discloses a fire-resistant container which comprises an inner layer separated from an outer layer by a thermally insulating layer. The prior art discloses a fire-resistant container which has a heat activated panel and a heat sensitive pin. The prior art discloses a fireproof container which comprises a plurality of layers. The prior art discloses a fire safe which includes a first door and a second door. The prior art discloses a fireproof container which includes a box and a lid hingedly coupled to the box. The prior art discloses an ornamental design for a memorabilia container which includes a box and a pair of lids each hingedly coupled to the box.

### (H) BRIEF SUMMARY OF THE INVENTION

An embodiment of the disclosure meets the needs presented above by generally comprising a tub that is comprised of a fire impermeable material to withstand temperatures associated with a house fire. The tub has a pair of recesses each integrated into the tub such that each of the recesses defines a grip for gripping and lifting the tub. A divider is positioned within the tub to define a first compartment and a second compartment in the tub to store memorabilia associated with a deceased person. A lid is removably attachable to the tub and a groove is integrated into the lid. The groove insertably engages an upper threshold of the tub to inhibit heat from entering the tub. The lid is comprised of a fire impermeable material to withstand temperatures associated with a house fire.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### I BRIEF DESCRIPTION OF SEVERAL VIEWS OF THE DRAWINGS

The disclosure will be better understood and objects other than those set forth above will become apparent when consideration is given to the following detailed description thereof. Such description makes reference to the annexed drawings wherein:

FIG. 1 is an exploded perspective view of a fire resistant container assembly according to an embodiment of the disclosure.

FIG. 2 is a right side exploded view of an embodiment of the disclosure.

FIG. 3 is a cross sectional view taken along line 3-3 of FIG. 2 of an embodiment of the disclosure.

FIG. 4 is a bottom view of an embodiment of the disclosure.

### (J) DETAILED DESCRIPTION OF THE INVENTION

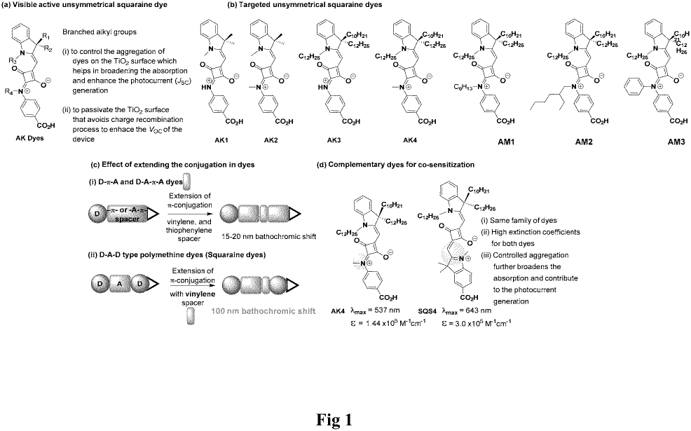

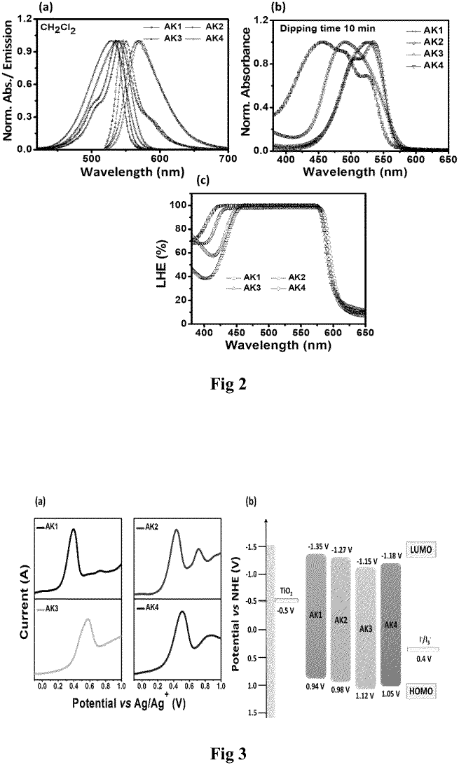

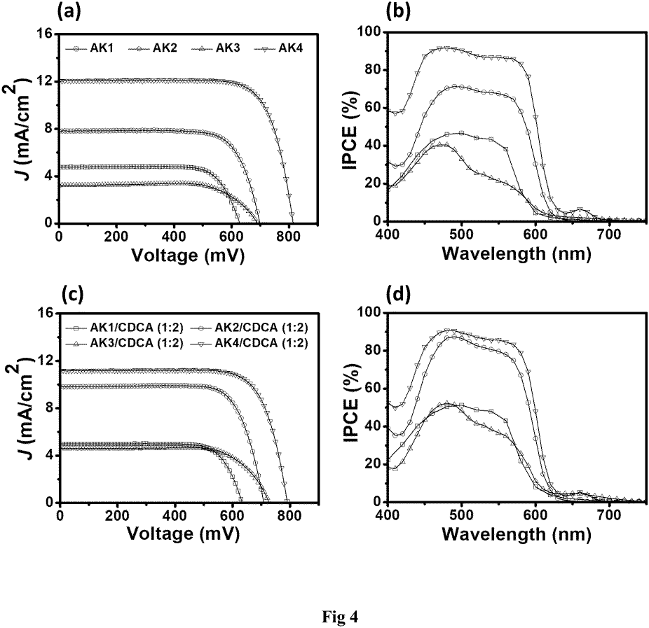

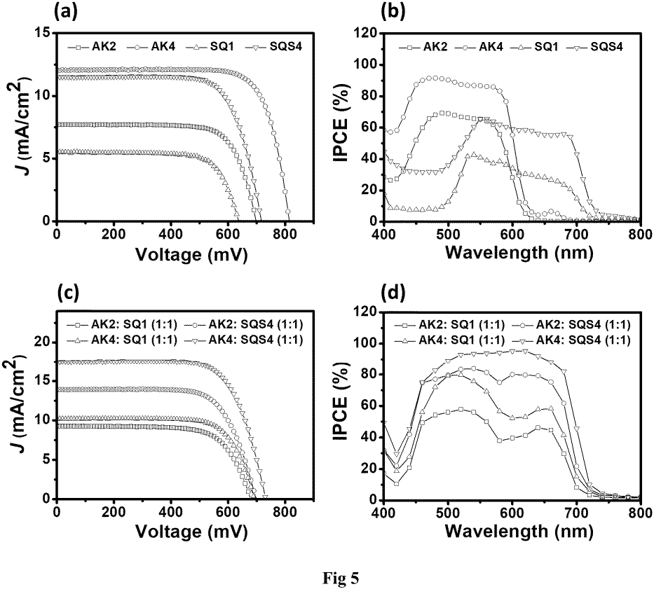

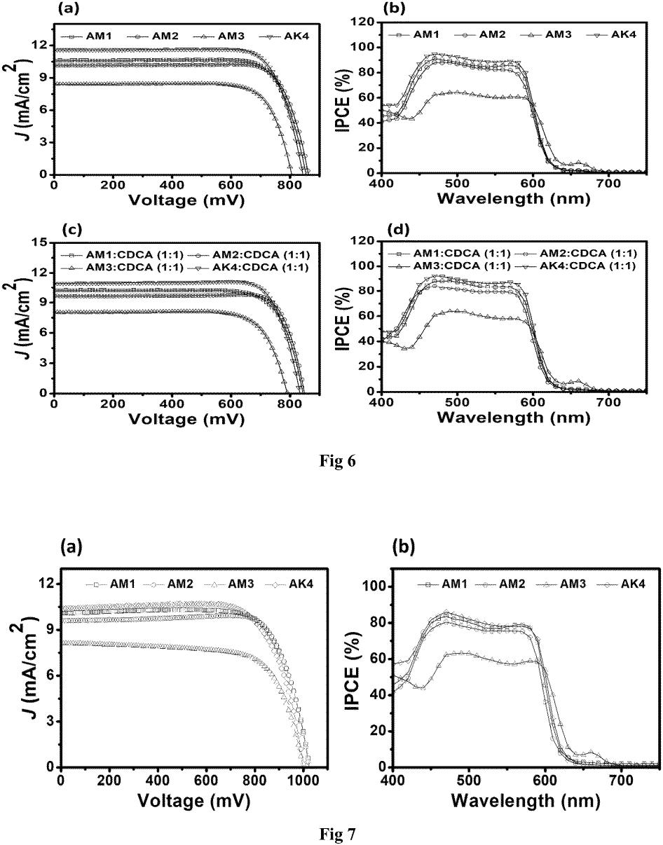

With reference now to the drawings, and in particular to FIGS. 1 through 4 thereof, a new container device embodying the principles and concepts of an embodiment of the disclosure and generally designated by the reference numeral 10 will be described.

As best illustrated in FIGS. 1 through 4, the fire resistant container assembly 10 generally comprises a tub 12 that is comprised of a fire impermeable material to withstand temperatures associated with a house fire. Furthermore, the tub 12 is comprised of a material that has a density is sufficiently low to facilitate a person of average strength to lift the tub 12. The tub 12 has a pair of recesses 14 each being integrated into the tub 12 such that each of the recesses 14 defines a grip 16 for gripping and lifting the tub 12. The tub 12 has a bottom wall 18 and an outer wall 20 extending upwardly from the bottom wall 18, and the outer wall 20 has a first lateral side 22, a second lateral side 24, a front side 26 and a back side 28. The outer wall 20 has a distal edge 30 with respect to the bottom wall 18 defining an opening 32 into the tub 12, and the outer wall 20 has an outer surface 34.

The outer wall 20 has a lip 36 extending outwardly from the outer surface 34. The lip 36 is aligned with the distal edge 30 and the lip 36 extends around each of the first lateral side 22, the second lateral side 24, the front side 26 and the back side 28 of the outer wall 20. The outer wall 20 has an inner surface 38 and the outer wall 20 has a pair of housings 40 each extending away from the inner surface 38. Each of the housings 40 is positioned on a respective one of the first lateral side 22 and the second lateral side 24 of the outer wall 20 such that each of the housings 40 defines a respective one of the recesses 14.

Each of the housings 40 has a lower wall 42 and an upper wall 44, and the lower wall 42 of each of the housings 40 curves upwardly from the inner surface 38 of the outer wall 20. The upper wall 44 of each of the housings 40 lies on a plane is perpendicularly oriented with the inner surface 38 of the outer wall 20 to be gripped for lifting the tub 12. The upper wall 44 of each of the housing lies on a plane that is oriented parallel with the bottom wall 18. Each of the housings 40 is positioned closer to the distal edge 30 of the outer wall 20 than the bottom wall 18. Each of the housings 40 is centrally positioned on the respective first lateral side 22 and the second lateral side 24. The outer wall 20 has a pair of openings 46 that is each aligned with a respective one of the housings 40 to insertably receive fingers for lifting the tub 12. Furthermore, each of the openings 46 has an upper bounding edge 48 is spaced downwardly from the upper wall 44 of the respective housing 40.

A divider 50 is positioned within the tub 12 to define a first compartment 52 and a second compartment 54 in the tub 12. Each of the first compartment 52 and the second compartment 54 can store memorabilia 56 associated with a deceased person. The memorabilia 56 may include large objects such as blankets, stuffed animals, and other personal items that were owned by the deceased person. The divider 50 extends between the front side 26 and the back side 28 of the outer wall 20 of the tub 12, and the divider 50 extends between the bottom wall 18 of the tub 12 and the distal edge 30 of the outer wall 20.

A lid 58 is provided that is removably attachable to the tub 12 and the lid 58 has a groove 60 that is integrated into the lid 58. The groove 60 insertably engages an upper threshold 62 of the tub 12 such that the lid 58 forms a fluid impermeable seal with the tub 12. In this way the lid 58 can inhibit heat from entering the tub 12. Additionally, the lid 58 is comprised of a fire impermeable material such that the lid 58 can withstand temperatures associated with a house fire.

The lid 58 has a top wall 64 and a perimeter wall 66 extending downwardly from the top wall 64, and the top wall 64 has a prominence 68 extending upwardly from the top wall 64. The prominence 68 is aligned with and is coextensive with the perimeter wall 66 such that the prominence 68 defines the groove 60. The distal edge 30 of the outer wall 20 of the tub 12 defines the upper threshold 62 of the tub 12 and the groove 60 insertably receives the distal edge 30 of the tub 12. The perimeter wall 66 of the lid 58 engages the lip 36 extending outwardly from the outer surface 34 of the outer wall 20 of the tub 12 when the lid 58 is positioned on the tub 12.

The tub 12 may be manufactured in a variety of sizes ranging between small, medium and large. The small size may a length and a height of approximately 12.0 inches and a width of approximately 14.0 inches. The medium size may have a length of approximately 16.0 inches, a width of approximately 18.0 inches and a height of approximately 12.0 inches. The large size may have a length of approximately 24.0 inches, a width of approximately 18.0 inches and a height of approximately 14.0 inches.

In use, the memorabilia 56 is positioned in a respective one of the first compartment 52 or the second compartment 54. The lid 58 is positioned on the tub 12 thereby ensuring the memorabilia 56 is protected from being damaged by a fire. Each of the recesses 14 can be gripped for lifting and transporting the tub 12. In this way the tub 12 facilitates the memorabilia 56 to be protected and the tub 12 can be more easily moved and transported as compared to a traditional fire safe.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A fire resistant container assembly for storing memorabilia of a deceased individual, said assembly comprising:
a tub being comprised of a fire resistant material wherein said tub is configured to withstand temperatures associated with a house fire, said tub being comprised of a material having a density being sufficiently low to facilitate a person of average strength to lift said tub, said tub having a pair of recesses each being integrated into said tub such that each of said recesses defines a grip for gripping and lifting said tub;
a divider being positioned within said tub to define a first compartment and a second compartment in said tub wherein each of said first compartment and said second compartment are configured to store memorabilia associated with a deceased person; and
a lid being removably attachable to said tub, said lid having a groove being integrated into said lid, said groove insertably engaging an upper threshold of said tub such that said lid forms a fluid impermeable seal with said tub wherein said lid is configured to inhibit heat from entering said tub, said lid being comprised of a fire resistant material wherein said lid is configured to withstand temperatures associated with a house fire.

2. The assembly according to claim 1, wherein:
said tub has a bottom wall and an outer wall extending upwardly from said bottom wall, said outer wall having a first lateral side, a second lateral side, a front side and a back side, said outer wall having a distal edge with respect to said bottom wall defining an opening into said tub, said outer wall having an outer surface, said outer wall having an inner surface;
said outer wall has a lip extending outwardly from said outer surface, said lip being aligned with said distal edge, said lip extending around each of said first lateral side, said second lateral side, said front side and said back side of said outer wall; and
said outer wall having a pair of housings each extending away from said inner surface, each of said housings being positioned on a respective one of said first lateral side and said second lateral side of said outer wall such that each of said housings defines a respective one of said recesses.

3. The assembly according to claim 2, wherein:
each of said housings has a lower wall and an upper wall;
said lower wall of each of said housings curving upwardly from said inner surface of said outer wall; and
said upper wall of each of said housings lying on a plane being perpendicularly oriented with said inner surface of said outer wall wherein said upper wall of each of said housings is configured to be gripped for lifting said tub.

4. The assembly according to claim 3, wherein said upper wall of each of said housing lies on a plane being oriented parallel with said bottom wall, each of said housings being positioned closer to said distal edge of said outer wall than said bottom wall, each of said housings being centrally positioned between said front side and said back side on said respective first lateral side and said second lateral side.

5. The assembly according to claim 3, wherein:
said outer wall has a pair of openings each being aligned with a respective one of said housings wherein each of said openings is configured to insertably receive fingers for lifting said tub such that each opening defines a respective one of said recesses; and
each of said openings has an upper bounding edge being spaced downwardly from said upper wall of said respective housing.

6. The assembly according to claim 2, wherein said divider extends between said front side and said back side of said outer wall of said tub, said divider extending between said bottom wall of said tub and said distal edge of said outer wall.

7. The assembly according to claim 2, wherein:
said lid has a top wall and a perimeter wall extending downwardly from said top wall;
said top wall has a prominence extending upwardly from said top wall, said prominence being aligned with and being coextensive with said perimeter wall such that said prominence defines said groove;
said distal edge of said outer wall of said tub defining said upper threshold of said tub;
said groove insertably receives said distal edge of said tub; and
said perimeter wall of said lid engages said lip extending outwardly from said outer surface of said outer wall of said tub when said lid is positioned on said tub.

8. A fire resistant container assembly for storing memorabilia of a deceased individual, said assembly comprising:
a tub being comprised of a fire resistant material wherein said tub is configured to withstand temperatures associated with a house fire, said tub being comprised of a material having a density being sufficiently low to facilitate a person of average strength to lift said tub, said tub having a pair of recesses each being integrated into said tub such that each of said recesses defines a grip for gripping and lifting said tub, said tub having a bottom wall and an outer wall extending upwardly from said bottom wall, said outer wall having a first lateral side, a second lateral side, a front side and a back side, said outer wall having a distal edge with respect to said bottom wall defining an opening into said tub, said outer wall having an outer surface, said outer wall having a lip extending outwardly from said outer surface, said lip being aligned with said distal edge, said lip extending around each of said first lateral side, said second lateral side, said front side and said back side of said outer wall, said outer wall having an inner surface, said outer wall having a pair of housings each extending away from said inner surface, each of said housings being positioned on a respective one of said first lateral side and said second lateral side of said outer wall such that each of said housings defines a respective one of said recesses, each of said housings having a lower wall and an upper wall, said lower wall of each of said housings curving upwardly from said inner surface of said outer wall, said upper wall of each of said housings lying on a plane being perpendicularly oriented with said inner surface of said outer wall wherein said upper wall of each of said housings is configured to be gripped for lifting said tub, said upper wall of each of said housing lying on a plane being oriented parallel with said bottom wall, each of said housings being positioned closer to said distal edge of said outer wall than said bottom wall, each of said housings being centrally positioned between said front side and said back side on said respective first lateral side and said second lateral side, said outer wall having a pair of openings each being aligned with a respective one of said housings wherein each of said openings is configured to insertably receive fingers for lifting said tub such that each opening defines a respective one of said recesses, each of said openings having an upper bounding edge being spaced downwardly from said upper wall of said respective housing;
a divider being positioned within said tub to define a first compartment and a second compartment in said tub wherein each of said first compartment and said second compartment are configured to store memorabilia associated with a deceased person, said divider extending between said front side and said back side of said outer wall of said tub, said divider extending between said bottom wall of said tub and said distal edge of said outer wall; and
a lid being removably attachable to said tub, said lid having a groove being integrated into said lid, said groove insertably engaging an upper threshold of said tub such that said lid forms a fluid impermeable seal with said tub wherein said lid is configured to inhibit heat from entering said tub, said lid being comprised of a fire resistant material wherein said lid is configured to withstand temperatures associated with a house fire, said lid having a top wall and a perimeter wall extending downwardly from said top wall, said top wall having a prominence extending upwardly from said top wall, said prominence being aligned with and being coextensive with said perimeter wall such that said prominence defines said groove, said distal edge of said outer wall of said tub defining said upper threshold of said tub, said groove insertably receiving said distal edge of said tub, said perimeter wall of said lid engaging said lip extending outwardly from said outer surface of said outer wall of said tub when said lid is positioned on said tub.
